(19) United States
(12) Patent Application Publication
(10) Pub. No.: US 2010/0309464 A1
(43) Pub. Date: Dec. 9, 2010

(54) Raman Chemical Imaging of Threat Agents Using Pulsed Laser Excitation and Time-Gated Detection

(75) Inventors: Patrick J. Treado, Pittsburgh, PA (US); Matthew Nelson, Harrison City, PA (US); Jeffrey Cohen, Pittsburgh, PA (US); John Maier, Pittsburgh, PA (US)

Correspondence Address: CHEMIMAGE CORPORATION, 7301 PENN AVENUE, PITTSBURGH, PA, 15208, US

(73) Assignee: ChemImage Corporation, Pittsburgh, PA (US)

(21) Appl. No.: 12/619,336

(22) Filed: Nov. 16, 2009

Related U.S. Application Data
(63) Continuation-in-part of application No. 11/728,430, filed on Mar. 26, 2007, now Pat. No. 7,649,618.
(60) Provisional application No. 61/199,236, filed on Nov. 14, 2008.

(51) Int. Cl. G01J 3/44

(52) U.S. Cl. 356/301

(57) ABSTRACT

The disclosure provides for a system and method for detecting a threat agent. A sample is illuminated to produce photons Raman scattered and emitted by the sample. The Raman scattered photons are collected using time-gated detection without collecting the emitted photons. A Raman spectroscopic data set is generated from said Raman scattered photons wherein said Raman spectroscopic data comprises at least one of a Raman spectrum and a Raman chemical image. The Raman spectroscopic data is assessed to thereby determine the presence or absence of a threat agent in the sample. The sample may be in a target area. The sample may be illuminated using a pulsed laser or an intensity modulated laser. The illumination source may be synchronized with a gating element that enables time-gated detection.

### RELATED APPLICATIONS

This application claims priority to U.S. Provisional Application No. 61/199,236, filed on Nov. 14, 2008, entitled “Raman Chemical Imaging of Threat Agents Using Pulsed Laser Excitation and Time-Gated Detection. This application is also a continuation-in-part of U.S. application Ser. No. 11/728,430, filed on Mar. 26, 2007, entitled “System and Method to Perform Raman Imaging without Luminescence.” These applications are hereby incorporated by reference in their entireties.

### BACKGROUND OF THE INVENTION

Raman spectroscopy and Raman chemical imaging are non-destructive, non-contact and require little to no sample preparation. Raman chemical imaging combines spectroscopy and digital imaging processing to provide images with contrast based on chemical structure that detail morphology, composition and structure. One example of an apparatus used for chemical imaging is taught in U.S. Pat. No. 6,002,476, entitled “Chemical Imaging System”, to Treado et al. Another example of an apparatus used for chemical imaging is taught in U.S. Pat. No. 7,019,296, entitled “Near Infrared Chemical Imaging Microscope”, to Treado et al.

Historically, instruments have used Continuous Wave (“CW”) laser sources to excite the sample or target area being analyzed. One issue that often plagues the use of CW laser sources during Raman spectroscopy is autofluorescence of the sample. This “contaminating” effect may be reduced by photobleaching the sample material prior to Raman imaging, the process using repeated laser exposure to decrease fluorescence. However, this additional photobleaching step may not be desirable or practical depending on the sample material at hand because the process is time consuming, ranging from minutes to hours to complete. When detecting threat agents, time is of the essence. Therefore, there is a need for a rapid and reliable system and method for using Raman spectroscopic methods to detect threat agents.

Additionally, there is generally a tradeoff between Raman intensity, the interference of background fluorescence on the measurement, the measurement time and the photodecomposition of the sample with the excitation wavelength. Therefore there is a need for a rapid and reliable system that effectively reduces the “contaminating” fluorescence interference.

### SUMMARY OF THE INVENTION

The present disclosure provides for a system and method for detecting threat agents that allows for the rapid and reliable (high probability of detection and low false alarm rates) generation of Raman spectroscopic data in the absence of contaminating fluorescence interference. This is possible by effectively “gating out” (not detecting) photons fluorescently emitted from the sample upon illumination, or at least effectively gating out a substantial amount of the emitted photons so as to not “contaminate” the Raman spectroscopic data. Such an embodiment prevents fluorescent contamination without the need to photobleach the sample. The present disclosure also provides for the use of pulsed lasers and intensity modulated lasers that can be synchronized with at least one gating element to provide for effective time-gated detection. The embodiments also hold potential for increasing the signal-to-noise ratio (SNR) and can be used to detect threats present in air, water, on surfaces and at standoff distances. The embodiments disclosed herein can also be used to detect threat agents in complex matrices. The advantages of using pulsed or intensity modulated laser excitation and time-gated detection over CW laser excitation and non-gated detection are discussed throughout the present disclosure, including application of this approach in an imaging format.

### BRIEF DESCRIPTION OF THE DRAWINGS

FIG. 1 is illustrative of a method of the present disclosure.

FIG. 2 is representative of the FAST concept.

FIG. 3 is representative of the MCF concept.

FIG. 4 is illustrative of a method of the present disclosure.

FIG. 5 is illustrative of a method of the present disclosure.

FIG. 6 is a schematic of a system of the present disclosure.

FIG. 7 is representative of FAST Raman chemical imaging of BWA mixtures.

FIG. 8 is representative of a comparison of the MCF vs. an Evans split element LCTF.

FIG. 9 is representative of a APICD Gen II Raman Aeorsol Monitor for the automated analysis of Bt (in G Media).

FIG. 10 is representative of a Raman Bio Identification Robot (RBI) for the remote detection of Bacillus globigii (Bg).

FIG. 11 is illustrates the use of a Chemlmage standoff Raman system.

FIG. 12 is illustrates the use of a ChemImage standoff Raman system.

FIG. 13 is a schematic representation of a system of the present disclosure.

### DETAILED DESCRIPTION

Reference will now be made in detail to certain embodiments of the present disclosure, examples of which are illustrated in the accompanying figures. It is to be understood that the figures and descriptions of the present disclosure included herein illustrate and describe elements that are of particular relevance to the present disclosure, while eliminating, for the sake of clarity, other elements found in typical chemical imaging systems.

It is noted here that in the discussion herein the terms “illumination,” “illuminating,” “irradiation,” and “excitation” may used interchangeably as can be evident from the context. For example, the terms “illumination source,” “light source,” and “excitation source” may used interchangeably. Similarly, the terms “illuminating photons” and “excitation photons” may also be used interchangeably. Additionally, the terms “time-gated detection” and “time resolved image capture” may be used to refer to the same, similar, or like concepts. A system and method implementing “time resolved image capture”, is more fully described in U.S. patent application Ser. No. 11/728,430, entitled “System and Method to Perform Raman Imaging Without Luminescence”, which is hereby incorporated by reference in its entirety.

Furthermore, although the discussion hereinbelow focuses more on Raman spectroscopy and Raman chemical imaging, various methodologies discussed herein may be adapted to be used in conjunction with other types of spectroscopy applications as can be evident to one skilled in the art based on the discussion provided herein. Other spectroscopic applications may include but are not limited to: fluorescence, ultraviolet, infrared, and visible, among others.

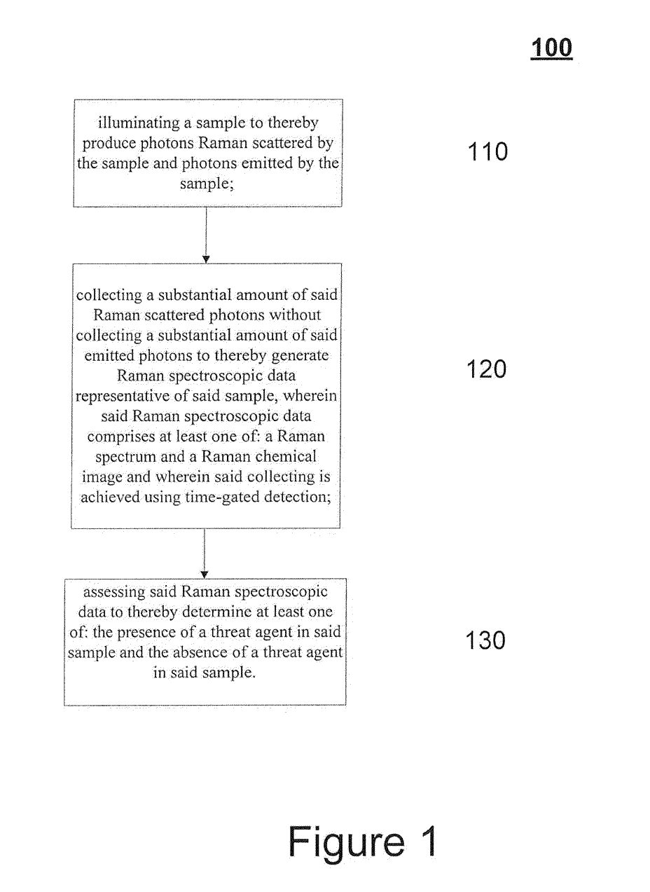

The present disclosure provides for a system and method for detecting threat agents. In one embodiment, the present disclosure provides for a method 100, illustrated by FIG. 1, wherein a sample is illuminated to thereby produce photons Raman scattered by the sample and photons emitted by the sample in step 110. In step 120 a substantial amount of said Raman scattered photons are collected without collecting a substantial amount of the emitted photons to thereby generate Raman spectroscopic data representative of said sample, wherein said Raman spectroscopic data comprises at least one of: a Raman spectrum and a Raman chemical image. In step 130 the Raman spectroscopic data is assessed to thereby determine at least one of: the presence of a threat agent in the sample and the absence of a threat agent in the sample.

It is also contemplated by this disclosure that, in addition to photons Raman scattered by the sample and emitted by the sample, other photons may be absorbed by the sample or transmitted by the sample. In one embodiment, the sample is illuminated using wide-field illumination. In one embodiment, the sample may be illuminated using a pulsed laser light. The pulsed laser light may comprise a substantially monochromatic pulsed laser light. In another embodiment, the sample may be illuminated using an intensity modulated laser light. The intensity modulated laser light may comprise a substantially monochromatic intensity modulated laser light.

In one embodiment, the Raman scattered photons are collected using time-gated detection. In one embodiment, the time-gated detection may comprise the use of a gating element that is configured to be open for a predetermined period of time wherein said predetermined period of time is such that a substantial amount of Raman scattered photons are passed though said gating element and a substantial amount of emitted photons are not passed though said gating element. Such “gating out” of the emitted photons is possible because fluorescence emission time is longer than Raman emission time.

In one embodiment, the Raman scattered photons are produced during a Raman emission time period and the emitted photons are produced during a fluorescence emission time period. In one embodiment, the gating element is open for a predetermined period of time wherein the predetermined period of time is less than said fluorescence emission time period. In another embodiment, the gating element is open for a predetermined period of time wherein the predetermined period of time is substantially equal to the Raman emission time. The present disclosure contemplates that the gating element may also be configured to be open for other periods of time as needed or desired.

A Raman signal is generated about 1 picosecond after illumination whereas a fluorescence signal (emitted photons) is not generated until after 1 to 2 nanoseconds of illumination. Therefore, the gating element can be configured to close after the Raman signal is generated, thereby preventing any fluorescence signals from passing through the gating element and being detected.

In one embodiment, the Raman emission time may overlap with the fluorescence emission time. However, such a small amount of the emitted photons would pass through the gating element as to not interfere substantially with the Raman spectroscopic data.

The gating element may be any known in the art including but not limited to: a microchannel plate image intensifier, a pockels cell, a Kerr shutter, a vandium dioxide thin film shutter, a polarization-discriminating Mach-Zehnder optical switch, and a suitably designed photonic crystal based shutter. The present disclosure also contemplates the use of a laser as the gating element. In one embodiment, this laser is the same as the laser light source that illuminates a target area or a sample. In another embodiment, this laser can be another laser in addition to the laser light source that illuminates a target area or a sample. The present disclosure also contemplates the use of spatial propagation (i.e. Spatially Offset Raman Spectroscopy, “SORS”) as a type of switching mechanism.

In one embodiment, all of the Raman scattered photons are collected. In another embodiment, none of the emitted photons are collected. In yet another embodiment, some emitted photons may be collected, but in such a small amount so as to not produce a “contaminating” fluorescence effect. In one embodiment, the Raman chemical image is a spatially accurate wavelength resolved Raman chemical image in which a fully resolved spectrum unique to the material for each pixel location in the image is obtained. In one embodiment, the Raman chemical image can be overlaid or fused with a digital image representative of the sample. The Raman chemical image, may also be overlaid or fused with a bright field image representative of the sample.

The threat agent found to be present in the sample or absent from the sample may be any known in the art including but not limited to a biological threat agent, a chemical threat agent, a explosive threat agent, and combinations thereof. The explosive threat agent may comprise an improvised explosive device. The threat agent may also be a hazardous agent.

Once Raman spectroscopic data is generated, it can be assessed to determine either the presence of a threat agent in the sample or the absence of a threat agent in the sample. The Raman spectroscopic data may be assessed using any method known in the art. In one embodiment, said assessing may comprise comparing the Raman spectroscopic data with reference spectroscopic data in a reference data base. In one embodiment, the same or target area may comprise more than one unknown material. In such case, spectral unmixing techniques may be used to assess the Raman spectroscopic data. In such technique is more fully described in U.S. Pat. No. 7,072,770, entitled “Method for Indentifying Components of a Mixture Via Spectral Analysis”, which is hereby incorporated by reference in its entirety. Other analysis methods that may be implemented include the following U.S. patent applications, hereby incorporated by reference in their entireties: U.S. application Ser. No. 11/450,138, entitled “Forensic Integrated Search Technology”; U.S. application Ser. No. 12/017,445, entitled “Forensic Integrated Search Technology with Instrument Weight Factor Determination”; U.S. application Ser. No. 12/196,921, entitled “Adaptive Method for Outlier Detection and Spectral Library Augmentation”; and U.S. application Ser. No. 12/339,805, entitled “Detection of Pathogenic Microorganisms Using Fused Sensor Data.

In addition, chemometric techniques may be applied to the Raman spectroscopic data for further analysis. Such techniques may be any known in the art, including but are not limited to: principal component analysis (PCA), Cosine Correlation Analysis (CCA), Euclidian Distance Analysis (EDA), multivariate curve resolution (MCR), Band T. Entropy Method (BTEM) Mahalanobis Distance (MD), Adaptive Subspace Detector (ASD).

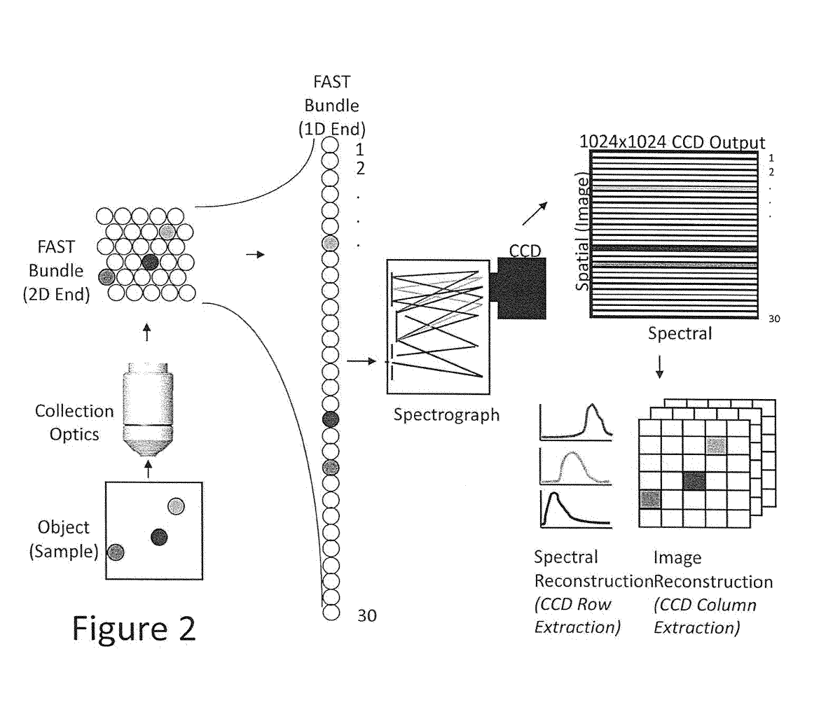

In one embodiment, the method may further comprise passing the Raman scattered photons through a Fiber Array Spectral Translator (FAST) device. The FAST concept is illustrated in FIG. 2. With FAST, light from the sample is focused onto a 2D bundle of optical fibers that is drawn to a linear array, of fibers at the opposite end. The 1D end is positioned at the entrance slit of a dispersive spectrometer. A set of spatially resolved spectra and spectrally resolved images are reconstructed from the dispersed light detected from individual fibers on a single CCD image.

A Fiber Array Spectral Translator (“FAST”) system when used in conjunction with a photon detector allows massively parallel acquisition of full-spectral images. A FAST system can provide rapid real-time analysis for quick detection, classification, identification, and visualization of the sample. The FAST technology can acquire a few to thousands of full spectral range, spatially resolved spectra simultaneously. A typical FAST array contains multiple optical fibers that may be arranged in a two-dimensional array on one end and a one dimensional (i.e., linear) array on the other end. The linear array is useful for interfacing with a photon detector, such as a charge-coupled device (“CCD”). The two-dimensional array end of the FAST is typically positioned to receive photons from a sample. The photons from the sample may be, for example, emitted by the sample, reflected off of the sample, refracted by the sample, fluoresce from the sample, or scattered by the sample. The scattered photons may be Raman photons.

In a FAST spectrographic system, photons incident to the two-dimensional end of the FAST may be focused so that a spectroscopic image of the sample is conveyed onto the two-dimensional array of optical fibers. The two-dimensional array of optical fibers may be drawn into a one-dimensional distal array with, for example, serpentine ordering. The one-dimensional fiber stack may be operatively coupled to an imaging spectrograph of a photon detector, such as a charge-coupled device so as to apply the photons received at the two-dimensional end of the FAST to the detector rows of the photon detector.

One advantage of this type of apparatus over other spectroscopic apparatus is speed of analysis. A complete spectroscopic imaging data set can be acquired in the amount of time it takes to generate a single spectrum from a given material. Additionally, the FAST can be implemented with multiple detectors. The FAST system allows for massively parallel acquisition of full-spectral images. A FAST fiber bundle may feed optical information from its two-dimensional non-linear imaging end (which can be in any non-linear configuration, e.g., circular, square, rectangular, etc.) to its one-dimensional linear distal end input into the photon detector. Given the advantageous ability of a FAST system to acquire hundreds to thousands of full spectral range, spatially-resolved spectra, such as Raman spectra, substantially simultaneously, a FAST system may be used in a variety of situations to help resolve difficult spectrographic problems

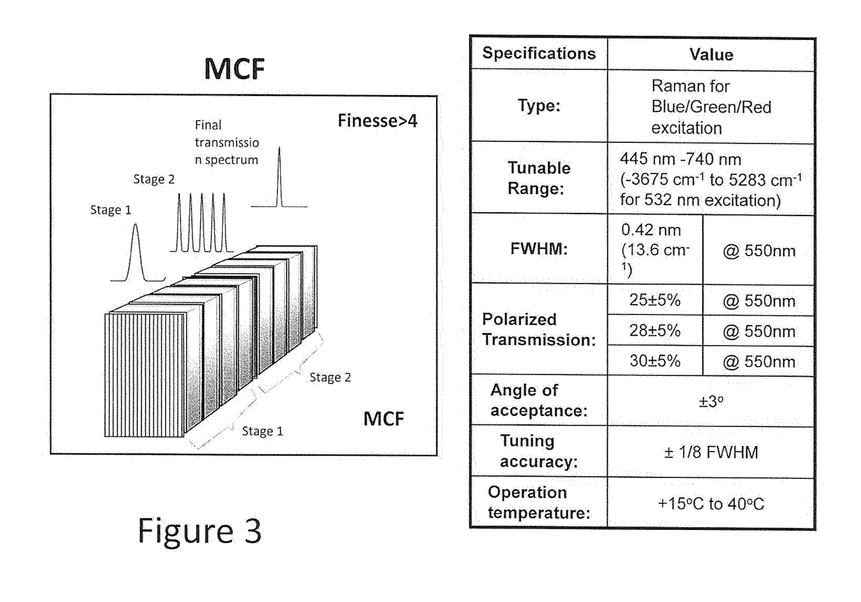

In one embodiment, the method further comprises passing the Raman scattered photons through a tunable filter. The tunable filter may be any known in the art including but not limited to: Liquid Crystal Tunable Filter (LCTF), Acousto-Optic Tunable Filter (AOTF), and a Multi-Conjugate Filter (MCF), among others. FIG. 3 is representative of a Multi-Conjugate Filter. The MCF is also more fully described in U.S. Pat. No. 7,362,489, entitled “Multi-conjugate Liquid Crystal Tunable Filter” and U.S. Pat. No. 6,992,809, entitled “Multi-conjugate Liquid Crystal Tunable Filter”. These patents are hereby incorporated by reference in their entireties.

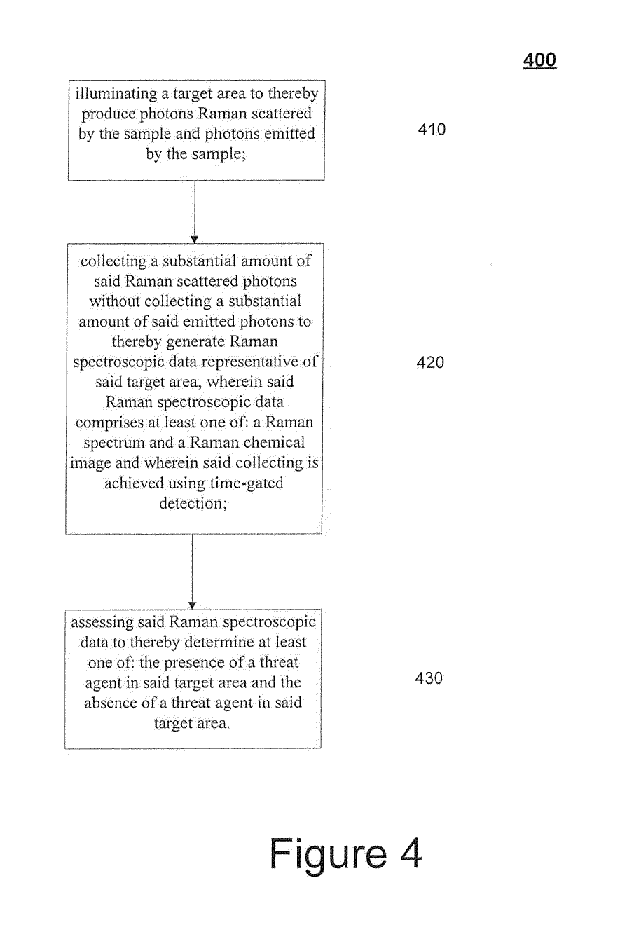

The present disclosure also provides for a method 400, illustrated by FIG. 4, wherein a target area having an unknown sample is illuminated to thereby produce photons Raman scattered by the sample and photons emitted by the sample in step 410. In one embodiment, the target area is illuminated at a standoff distance. In step 420 a substantial amount of Raman scattered photons are collected, using time-gated detection, without collecting a substantial amount of photons emitted from the sample to thereby generate Raman spectroscopic data representative of said target area, wherein said Raman spectroscopic data comprises at least one of: a Raman spectrum and a Raman chemical image. The Raman spectroscopic data is assessed in step 430 to thereby determine at least one of: the presence of a threat agent in the target area and the absence of a threat agent in the target area. In one embodiment, the Raman chemical image is overlaid or fused with a digital image representative of the target area. In another embodiment, a video camera can be used to target an area of interest.

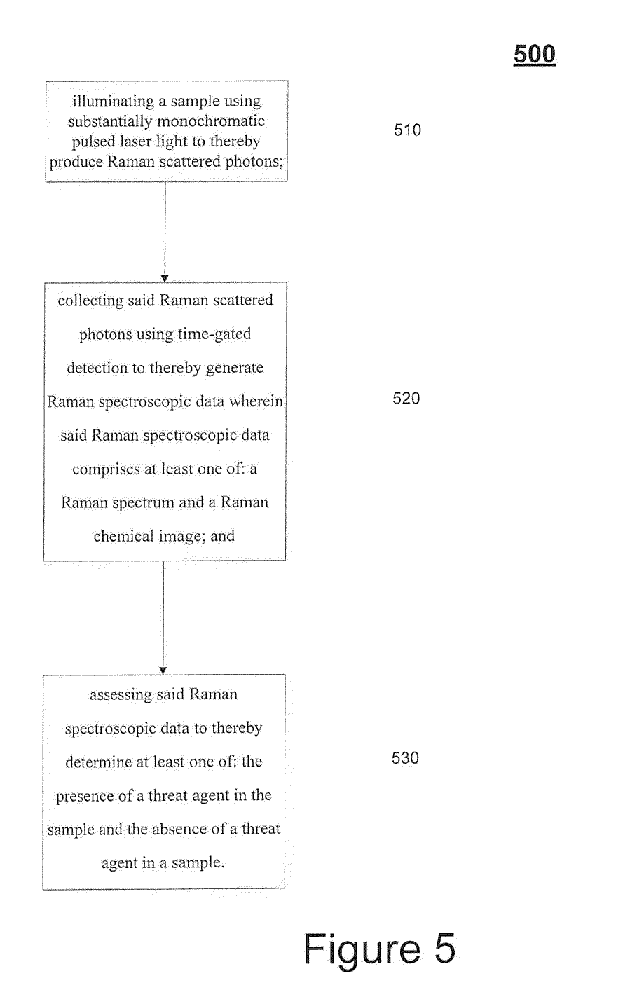

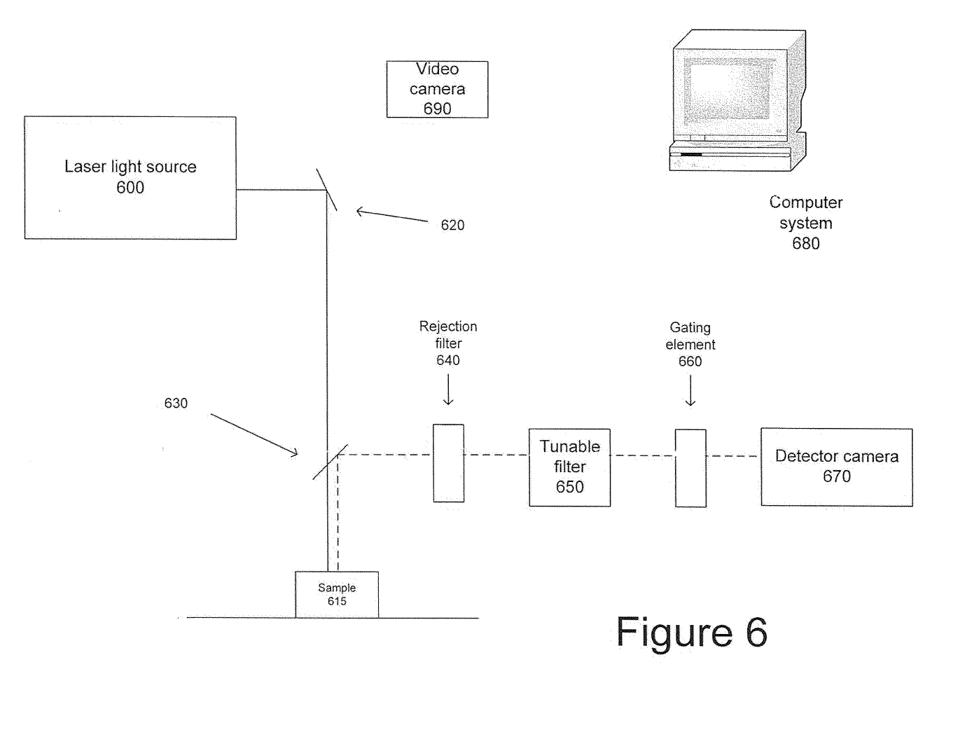

The present disclosure also provides for a method 500, illustrated by FIG. 5. The method comprises illuminating a sample using substantially monochromatic pulsed laser light to thereby produce Raman scattered photons in step 510. In step 520 the Raman scattered photons are collecting using time-gated detection to thereby generate Raman spectroscopic data wherein said Raman spectroscopic data comprises at least one of: a Raman spectrum and a Raman chemical image. In step 530 the Raman spectroscopic data is assessed to thereby determine at least one of: the presence of a threat in a sample and the absence of a threat in a sample.

The present disclosure also provides for a system 600, illustrated by FIG. 5. The system comprises a laser light source 610 for illuminating a sample 615. The laser light source may comprise a pulsed laser light source or an intensity modulated laser light source. The light produced by the source must be delivered to sample. A first optics 620 directs illuminating photons to said sample 615. In another embodiment, the light can be delivered directly though the use of mirrors and/or lenses. The light can also be propagated through a light guide such as a rigid telescope or laparoscope or through a flexible filter.

A second optics 630 collects photons scattered, emitted, absorbed, or transmitted by the sample 615. An illumination light rejection filter 640 is configured to block light of a first wavelength and allow light of a second wavelength to pass through said illumination light rejection filter. In one embodiment, said light of a second wavelength comprises Raman scattered photons. A tunable filter 650 receives said Raman scattered photons and passes ones of said Raman scattered photons having a predetermined wavelength band. In one embodiment, the tunable filter comprises a liquid crystal tunable filter. In another embodiment, element 650 may comprise a filter selected from the group consisting of: selected from the group consisting of a Fabry Perot angle tuned filter, an acousto-optic tunable filter, a liquid crystal tunable filter, a Lyot filter, an Evans split element liquid crystal tunable filter, a Sole liquid crystal tunable filter, a spectral diversity filter, a photonic crystal filter, a fixed wavelength Fabry Perot tunable filter, an air-tuned Fabry Perot tunable filter, a mechanically-tuned Fabry Perot tunable filter, and a liquid crystal Fabry Perot tunable filter. A gating element 660 is configured to open at a specified time, allowing said Raman scattered photons to pass through to a detector camera, thereby generating a Raman spectroscopic image of said region of said sample. In another embodiment of the present disclosure, the gating element 660 may comprise a microchannel plate image intensifier. Other embodiments provided for by the present disclosure may incorporate the use of at least one of pockets cell, Kerr shutter, vanadium dioxide thin film shutter, polarization-discriminating Mach-Zehnder optical switch, and suitably designed photonic crystal based shutters. The present disclosure also contemplates the use of a laser as a gating element. In one embodiment, this laser is the laser light source that illuminates a region of a sample. In another embodiment, this laser can be another laser in addition to the laser light source that illuminates a region of a sample. The system may also comprise the use of spatial propagation (i.e. Spatially Offset Raman Spectroscopy, “SORS”) as a type of switching mechanism.

In yet another embodiment, an optical component capable of acting as a gate, or intensity modulator which did not affect the wavelength of transmitted light and had appropriate temporal characteristics could be used in front of the tunable filter as an alternative to placing the gating element after the tunable filter.

The system may also comprise a computer system 680. The computer system can be configured to perform a variety of functions, including but not limited to, controlling the other elements of the system 680, collecting data, and storing the data collected by the system.

In one embodiment, the system further comprises a video camera, which may be a white light video camera. The video camera may be configured to perform a variety of functions, including but not limited to, targeting a region of interest of the sample. The video camera can also be configured to provide for simultaneous imaging in such a way that the Raman information obtained from the gated Raman imaging system could be overlaid with, or fused with the digital image of the sample in real time or off line.

In one embodiment, the system and method of the present disclosure may be operated in at least one of two modes including: a time-domain mode and a frequency-domain mode. In time-domain mode, when using a pulsed laser, the gate for the microchannel plate is synchronized to the laser in such a way that the gate is only opened for a brief time after the pulse of light has hit the sample and the light collected thereafter from the sample is traveling through the optics of the collection system. This delay is determined by the path length of the light through the optical system, and the lifetime of the fluorescence which is to be rejected. The closer the gate is to the initial photons which are collected from the sample after the interaction of the illuminating pulse with the sample, the more fluorescence can be rejected.

In frequency-domain mode, when using an intensity modulated laser, the gate for the microchannel plate can be operated at the same frequency as the laser modulation and adjusted in phase. This mode is usually referred to as homodyning. Through proper adjustment of the phase of the source and detector and frequency of modulation and application of appropriate mathematical methods, an accounting for fluorescence and ambient light can be achieved.

An alternative embodiment in the frequency-domain mode is to operate the laser and gating element at high but slightly different frequencies. This approach is commonly called heterodyning. Through appropriate choice of these frequencies and appropriate operation of the detector camera, measurement of the phase, DC and AC components of the signal can be obtained. Appropriate analysis of the phase DC and AC components at one or more base frequencies can allow independent estimation, and in some cases determination of the Raman signal and fluorescence signal, allowing for the construction of Raman and or fluorescence images.

In one embodiment of the frequency-domain mode provides for a tunable filter positioned before the modulated component of the detector in the optical path so that wavelength selection is performed with the tunable filter and detection is performed with the combination of gate and camera. In one embodiment, this detector may comprise the gating element and a camera.

In another embodiment, the system further comprises a white light video camera for simultaneous imaging in such a way that Raman information obtained from the gated Raman imaging system could be overlaid with or fused with the digital image of the sample. The overlay or fusion may take place either in real time or off line.

The present disclosure may be embodied in other specific forms without departing from the spirit or essential attributes of the disclosure. Accordingly, reference should be made to the appended claims, rather than the foregoing specification, as indicating the scope of the disclosure. Although the foregoing description is directed to the preferred embodiments of the disclosure, it is noted that other variations and modification will be apparent to those skilled in the art, and may be made without departing from the spirit or scope of the disclosure.

### Examples

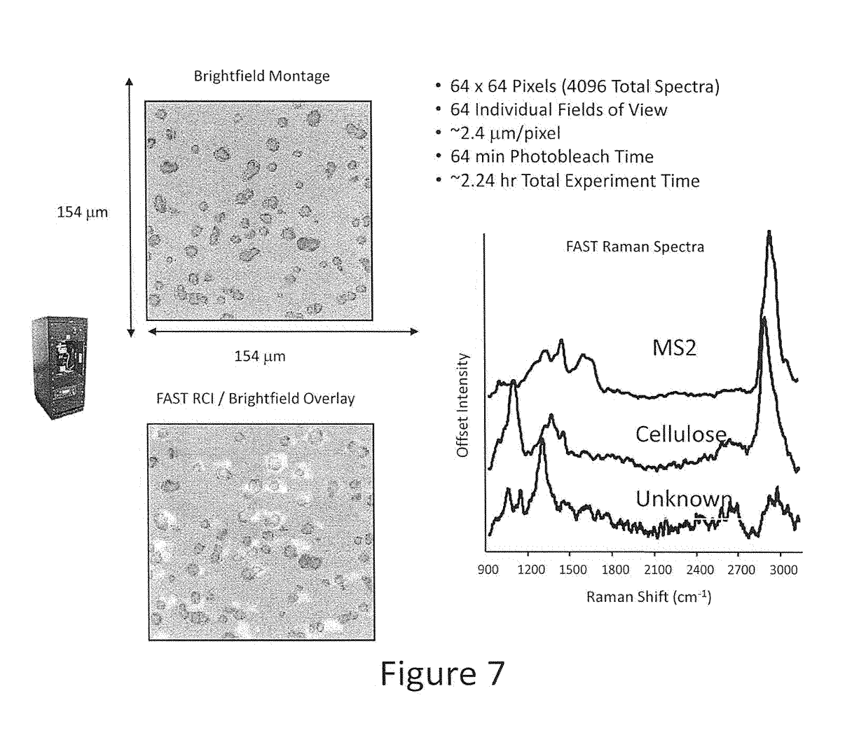

FIG. 7 is representative of FAST Raman chemical imaging of BWA mixtures. By using FAST, three components were found in the mixture. While FAST enables rapid detection of biological agents in complex mixtures, the rate limiting step is often the time required to photobleach the sample when using CW laser illumination and non-gated detection. In this experiment photobleach time made up almost half of the total experiment time.

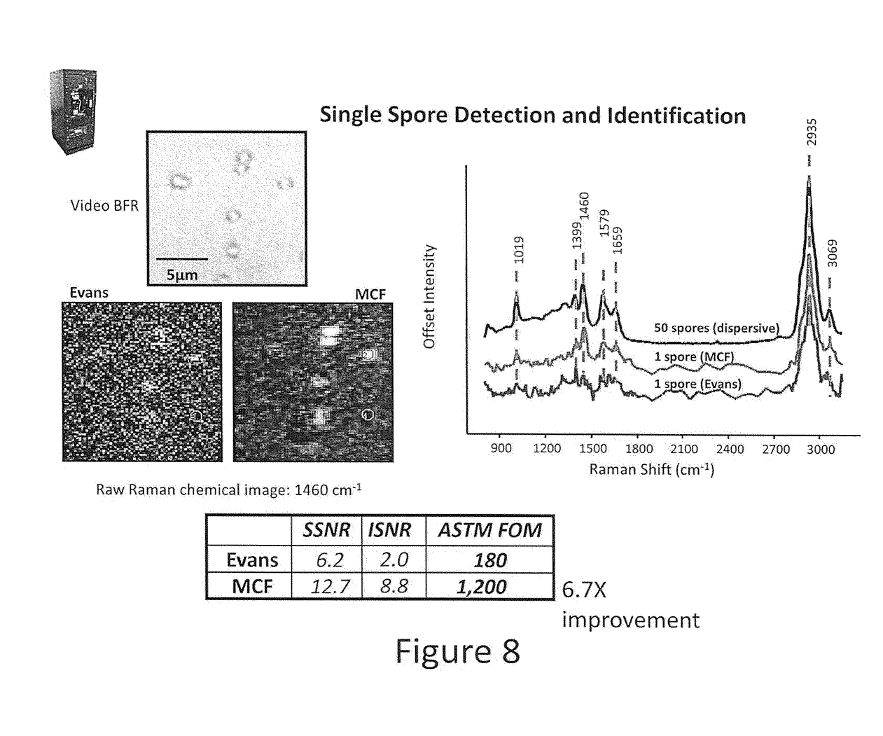

FIG. 8 illustrates a comparison of the use of a MCF vs. an Evans split element LCTF for single spore level detection of Bacillus globigii on an aluminum slide. This experiment illustrates an objective, side-by-side evaluation of two tunable filter types for comparing Raman chemical imaging performance. The results seem to indicate that the MCF gives a better SNR as compared to the Evans split element LCTF. A 6.7× improvement was seen for the MCF over the Evans split element LCTF when the ASTM FOM was calculated.

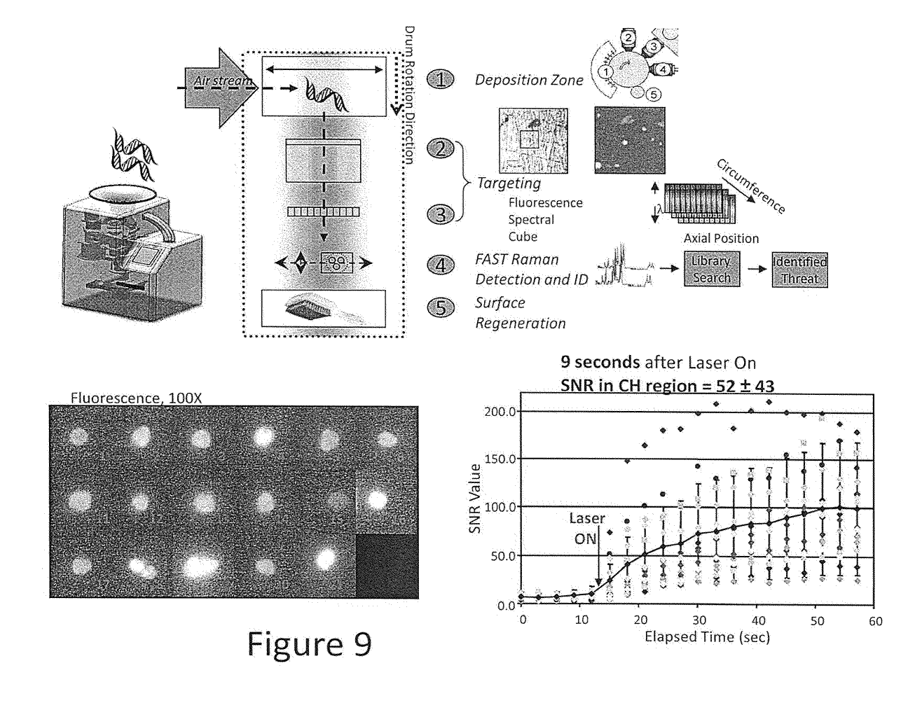

FIG. 9 is representative of APICD Gen II Raman Aerosol Monitor for the automated analysis of Bt (in G Media). Using a 100× objective, 21 Bt particles were found utilizing autofluorescence targeting. A Raman spectral SNR of 52±43 and 10±8 was observed in the CH region and fingerprint spectral regions, respectively, only nine (9) seconds after the laser was turned on. These results show that for some biological samples, good SNR is achievable in several seconds despite the autofluorescence produced by the sample.

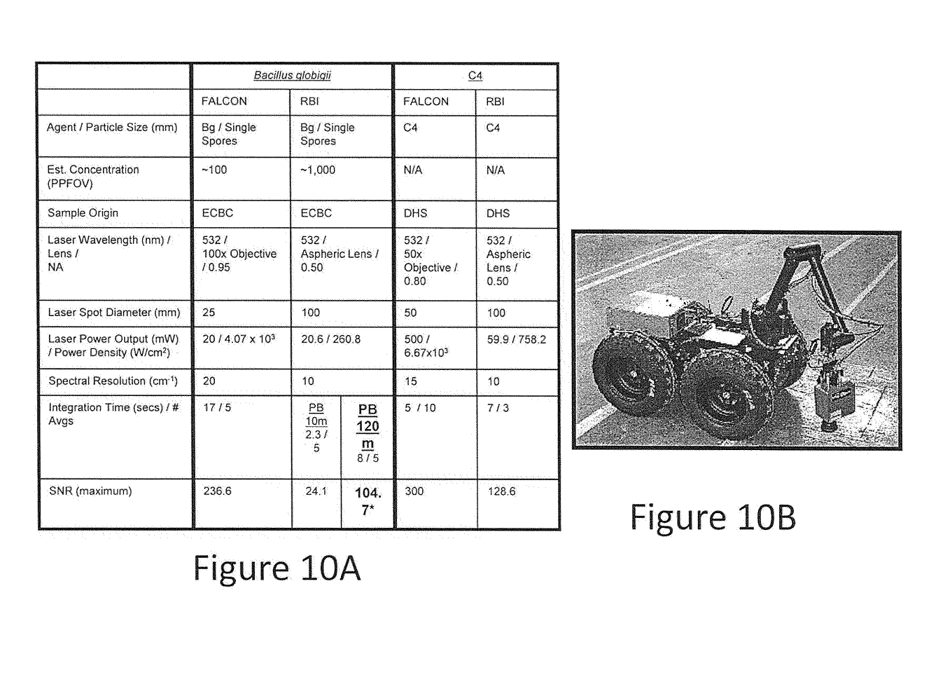

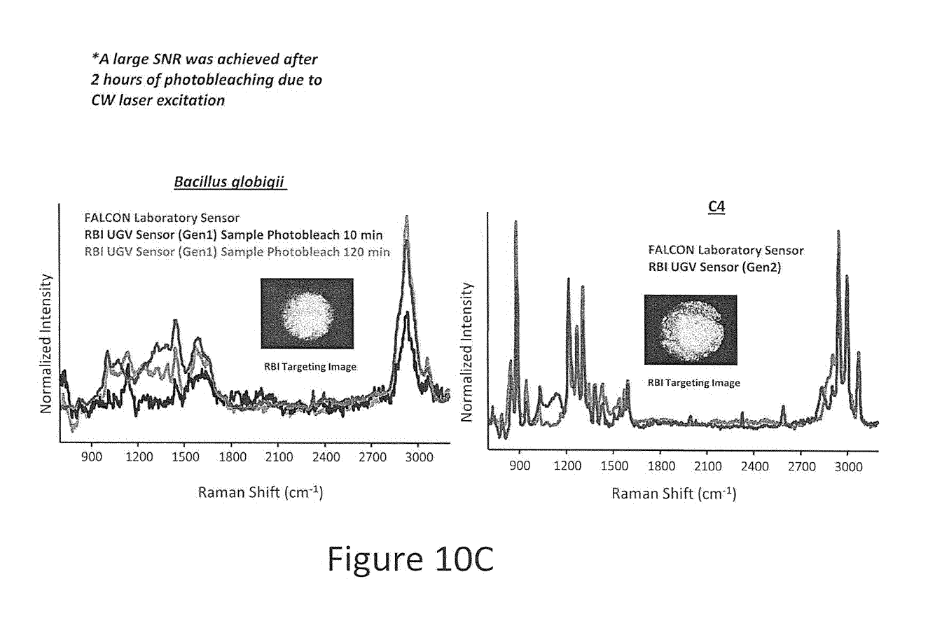

FIGS. 10A-10C are representative of the implementation of a Raman Bio Identification Robot (RBI) for the detection of Bacillus globigii (Bg) and C4. FIG. 10A represents the specifications used. FIG. 10B is illustrative of an embodiment of the RBI. FIG. 10C displays the results. High SNR spectra were obtained from the Bacillus globigii sample although a lengthy photobleach time (120 mins) was required when using CW laser excitation with non-gated detection.

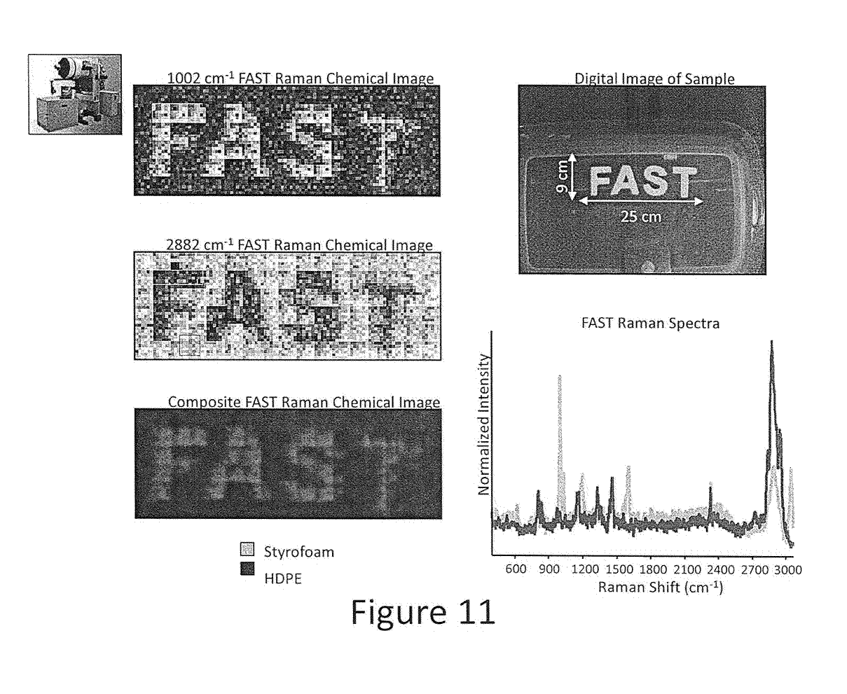

FIG. 11 is representative of a ChemImage standoff Raman system for the standoff FAST Raman chemical imaging of styrofoam (letters) on HDPE plastic. This Raman chemical image was collected at 30 m utilizing pulsed 532 nm laser excitation with time-gated ICCD detection.

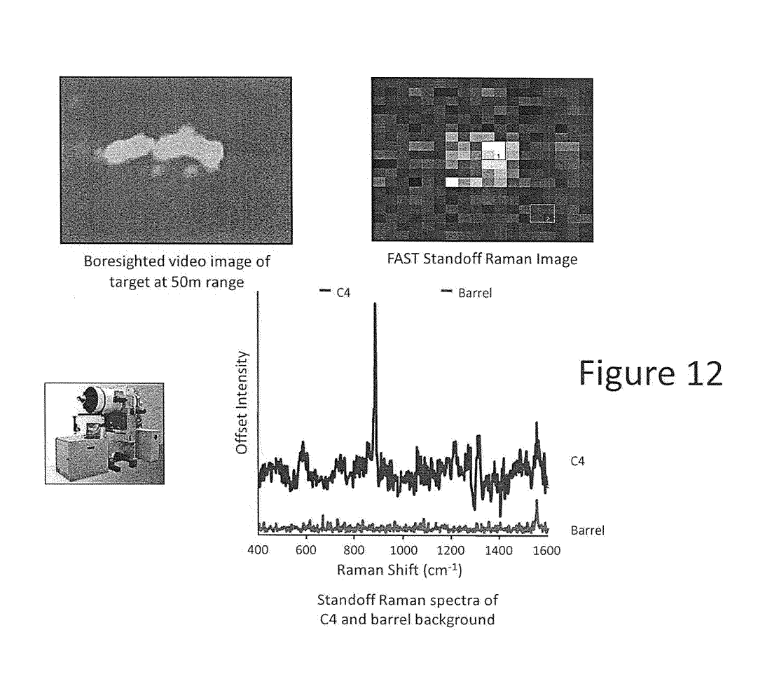

FIG. 12 is representative of a ChemImage standoff Raman system for FAST Raman imaging of C4 on a painted metal barrel at a 50 m standoff distance. The collected spectra show successful detection of an explosive material using pulse laser excitation and time-gated detection.

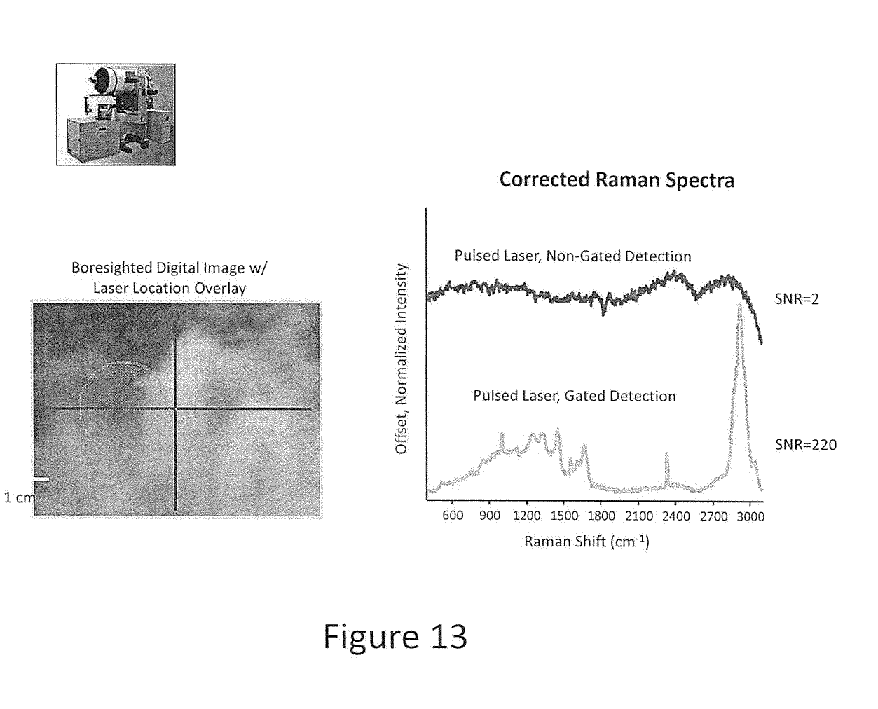

FIG. 13 is representative of a Chemlmage standoff Raman system comparing gated vs. non-gated Raman detection of ovalbumin on slate tile. Ovalbumin is a common biological agent simulant that exhibits substantial autofluorescence when using 532 nm CW excitation. Raman spectra were collected operating the system in both gated and non-gated modes. In non-gated mode, there are no detectable Raman features on top of the autofluorescence even after extensive photobleach periods. With gated detection, however, a high SNR Raman spectrum was achieved within seconds after the initial laser exposure.

What is claimed is:

1. A method comprising:
illuminating a sample to thereby produce photons Raman scattered by the sample and photons emitted by the sample;
collecting a substantial amount of said Raman scattered photons without collecting a substantial amount of said emitted photons to thereby generate Raman spectroscopic data representative of said sample, wherein said Raman spectroscopic data comprises at least one of: a Raman spectrum and a Raman chemical image and wherein said collecting is achieved using time-gated detection;
assessing said Raman spectroscopic data to thereby determine at least one of: the presence of a threat agent in said sample and the absence of a threat agent in said sample.

2. The method of claim 1 wherein said sample is illuminated using pulsed laser light.

3. The method of claim 1 wherein said sample is illuminated using an intensity modulated laser.

4. The method of claim 1 wherein said time-gated detection comprises configuring a gating element to open for a predetermined period of time wherein said predetermined period of time is such that a substantial amount of Raman scattered photons are passed through said gating element and a substantial amount of emitted photons are not passed through said gating element.

5. The method of claim 4 further comprising synchronizing said gating element with an illumination source so that said gating element opens at a time after illumination of the sample.

6. The method of claim 1 wherein said Raman chemical image is a spatially accurate wavelength resolved Raman chemical image.

7. The method of claim 1 wherein said sample is illuminated with substantially monochromatic light.

8. The method of claim 4 wherein said gating element comprises a microchannel plate image intensifier.

9. The method of claim 1 wherein said threat agent is selected from the group consisting of: a biological threat agent, a chemical threat agent, an explosive threat agent, and combinations thereof.

10. The method of claim 9 wherein said explosive threat agent comprises an improvised explosive device.

11. The method of claim 1 wherein said threat agent comprises a hazardous material.

12. The method of claim 1 further comprising passing said Raman scattered photons through a fiber array spectral translator device.

13. The method of claim 1 further comprising passing said Raman scattered photons through a filter.

14. The method of claim 13 wherein said filter is a tunable filter selected from the group consisting of: a liquid crystal tunable filter, a multi-conjugate filter, an acousto-optic tunable filter, and combinations thereof.

15. The method of claim 1 wherein said sample is illuminated using wide-field illumination.

16. The method of claim 1 further comprising fusing said Raman chemical image with a digital image representative of said sample.

17. The method of claim 1 wherein:
said Raman scattered photons are produced during a Raman emission time period and said emitted photons are produced during a fluorescence emission time period, and
wherein said time-gated detection comprises configuring a gating element to open for a predetermined period of time wherein said predetermined period of time is such that a substantial amount of said Raman scattered photons are passes though said gating element and a substantial amount of said emitted photons are not passed through said gating element.

18. The method of claim 17 further comprising synchronizing said gating element with an illumination source so that said gating element opens at a time after illumination of the sample.

19. The method of claim 17 wherein said predetermined period of time is less than said fluorescence emission time period.

20. The method of claim 17 wherein said predetermined period of time is substantially equal to said Raman emission time period.

21. The method of claim 1 wherein said sample is illuminated at a standoff distance.

22. A method comprising:
illuminating a target area having an unknown sample to thereby produce photons Raman scattered by the sample and photons emitted by the sample;
collecting a substantial amount of said Raman scattered photons without collecting a substantial amount of said emitted photons to thereby generate Raman spectroscopic data representative of said target area, wherein said Raman spectroscopic data comprises at least one of: a Raman spectrum and a Raman chemical image and wherein said collecting is achieved using time-gated detection;
assessing said Raman spectroscopic data to thereby determine at least one of: the presence of a threat agent in said target area and the absence of a threat agent in said target area.

23. The method of claim 22 further comprising synchronizing said gating element with an illumination source so that said gating element opens at a time after illumination of the sample.

24. The method of claim 22 wherein said target area is illuminated using pulsed laser light.

25. The method of claim 22 wherein said target area is illuminated using an intensity modulated laser.

26. The method of claim 22 wherein said time-gated detection comprises configuring a gating element to open for a predetermined period of time wherein said predetermined period of time is such that a substantial amount of Raman scattered photons are passed through said gating element and a substantial amount of emitted photons are not passed through said gating element.

27. The method of claim 22 wherein said Raman chemical image is a spatially accurate wavelength resolved Raman chemical image.

28. The method of claim 22 wherein said pulsed laser light comprises substantially monochromatic pulsed laser light.

29. The method of claim 26 wherein said gating element comprises a microchannel plate image intensifier.

30. The method of claim 22 wherein said threat agent is selected from the group consisting of: a biological threat agent, a chemical threat agent, an explosive threat agent, and combinations thereof.

31. The method of claim 30 wherein said explosive threat agent comprises an improvised explosive device.

32. The method of claim 22 wherein said threat agent comprises a hazardous material.

33. The method of claim 22 further comprising passing said Raman scattered photons through a fiber array spectral translator device.

34. The method of claim 22 further comprising passing said Raman scattered photons through a filter.

35. The method of claim 34 wherein said filter is a tunable filter selected from the group consisting of: a liquid crystal tunable filter, a multi-conjugate filter, an acousto-optic tunable filter, and combinations thereof.

36. The method of claim 22 wherein said target area is illuminated using wide-field illumination.

37. The method of claim 22 wherein said target area is illuminated at a standoff distance.

38. The method of claim 22 further comprising fusing said Raman chemical image with a digital image representative of said sample.

39. The method of claim 22 wherein
said Raman scattered photons are produced during a Raman emission time period and said emitted photons are produced during a fluorescence emission time period, and
wherein said time-gated detection comprises configuring a gating element to open for a predetermined period of time wherein said predetermined period of time is such that a substantial amount of said Raman scattered photons are passes though said gating element and a substantial amount of said emitted photons are not passed through said gating element.

40. The method of claim 39 wherein said predetermined period of time is less than said fluorescence emission time period.

41. The method of claim 39 wherein said predetermined period of time is substantially equal to said Raman emission time period.

42. A method comprising:
illuminating a sample using substantially monochromatic pulsed laser light to thereby produce Raman scattered photons;
collecting said Raman scattered photons using time-gated detection to thereby generate Raman spectroscopic data wherein said Raman spectroscopic data comprises at least one of: a Raman spectrum and a Raman chemical image; and
assessing said Raman spectroscopic data to thereby determine at least one of: the presence of a threat agent in the sample and the absence of a threat agent in a sample.

43. The method of claim 42 wherein said sample is illuminated as a result of illuminating a target area comprising said sample.

44. The method of claim 42 wherein said threat agent is selected from the group consisting of: a biological threat agent, a hazardous threat agent, a chemical threat agent, and an explosive threat agent.

45. The method of claim 42 further comprising passing said Raman scattered photons through a fiber array spectral translator device.

46. The method of claim 42 further comprising passing said Raman scattered photons through a tunable filter selected from the group consisting of: a liquid crystal tunable filter, a multi-conjugate filter, an acousto-optic tunable filter, and combinations thereof.

47. The method of claim 42 wherein said Raman scattered photons are produced during a Raman emission time period and said emitted photons are produced during a fluorescence emission time period, and
wherein said time-gated detection comprises configuring a gating element to open for a predetermined period of time wherein said predetermined period of time is such that a substantial amount of said Raman scattered photons are passes though said gating element and a substantial amount of said emitted photons are not passed through said gating element.

48. The method of claim 47 further comprising synchronizing said gating element with an illumination source so that said gating element opens at a time after illumination of the sample.

49. The method of claim 47 wherein said predetermined period of time is less than said fluorescence emission time period.

50. The method of claim 47 wherein said predetermined period of time is substantially equal to said Raman emission time period.

51. The method of claim 47 wherein said gating element comprises a microchannel plate image intensifier.

52. A system for detecting threat agents comprising:
a laser light source of illuminating a sample with photons to thereby produce photons selected from the group consisting of: Raman scattered photons, emitted photons, absorbed photons, transmitted photons, and combinations thereof;
a first optics to direct illuminating photons to said sample
a second optics to collect said photons wherein said photons are selected from the group consisting of: Raman scattered photons, emitted photons, absorbed photons, transmitted photons, and combinations thereof;
an illumination light rejection filter configured to block light of a first wavelength and allow light of a second wavelength to pass through said illumination rejection filter wherein said light of a second wavelength comprises said Raman scattered photons;
a tunable filter for receiving said Raman scattered photons and passing ones of a said Raman scattered photons having a wavelength in a predetermined wavelength band;
a gating element configured to open at a specified time, allowing said Raman scattered photons to pass through to a detector camera to thereby generate a Raman spectroscopic image of said region of said sample; and
a computer system configured to perform at least one of: control elements of said system, collect data from said system, and store data collected from said system.

53. The system of claim 52 further comprising a video camera.

54. The system of claim 52 wherein said tunable filter is selected from the group consisting of: a liquid crystal tunable filter, a multi-conjugate filter, an acousto-optic tunable filter, and combinations thereof.

55. The system of claim 52 wherein said gating element comprises a microchannel plate image intensifier.

56. The system of claim 52 wherein said illumination source comprises at least one of: a pulsed laser light source and an intensity modulated laser light source.

57. The system of claim 52 further comprising synchronizing said gating element with said illumination source so that said gating element opens at a time after illumination of the sample.

58. The system of claim 52 further comprising a fiber array spectral translator device.
